(19) United States
(12) Patent Application Publication
(10) Pub. No.: US 2011/0061560 A1
(43) Pub. Date: Mar. 17, 2011

(54) Apparatus and method for using electric fields to cause levitation on an uncharged and non-magnetized arbitrary surface

(76) Inventor: Anthony Emeka Nwankwo, Dallas, TX (US)

(21) Appl. No.: 12/802,357

(22) Filed: Jun. 4, 2010

Related U.S. Application Data
(63) Continuation-in-part of application No. 12/005,554, filed on Dec. 27, 2007, now abandoned.
(60) Provisional application No. 61/271,605, filed on Jul. 23, 2009.

(51) Int. Cl. B60L 13/04

(52) U.S. Cl. 104/281

(57) ABSTRACT

Methods and systems for levitation on uncharged and non-magnetized arbitrary surface are disclosed. The levitation system generates electric fields in order to cause dielectric polarization on the surface on which levitation is to be caused. Methods and systems are disclosed in which the polarity of the electric field that is produced by the system is switched in a controlled manner. Due to kinetic inertia of the effective dipole moment of the uncharged and non-magnetized arbitrary surface, the dipole moment cannot maintain the changes in response to the changes in polarity of the electric field that is produced by the levitation system and thus, a repulsive force is generated between the levitation system and the non-magnetized arbitrary surface. The controlled repulsive force initiates and maintains the desired level of levitation with respect to the uncharged and non-magnetized arbitrary surface. Additionally the source of electric fields is made to have a large area in order to increase the repulsive force on the levitation system.

### CROSS-REFERENCE TO RELATED APPLICATIONS

This application is a continuation in part of Ser. No. 12/005,554, filed on Dec. 27, 2007 by the present inventor.

This application claims the benefit of provisional patent application Ser. No. 61/271,605, filed on Jul. 23, 2009 by the present inventor, which is incorporated by reference.

### STATEMENT REGARDING FEDERALLY SPONSORED RESEARCH OR DEVELOPMENT

Not applicable.

### BACKGROUND

1. Technical Field

This disclosure relates to using electric fields to cause levitation of a vehicle. More specifically, it relates to levitation and horizontal motion of a vehicle, which operates on an uncharged and non-magnetized arbitrary surface by using electric fields.

2. Background

Since several decades, levitation systems have been used in a variety of industrial and other applications. For example, magnetic levitation systems have been used for railroad trains, steel structures etc.

There are several issued patents and published application. For example, a published application No. US 2001/0045311 A1 describes a control levitation vehicle, which uses rope shuttles where the vehicle is towed by a rope, and a linear shuttle where the vehicle is driven by a linear motor.

U.S. Pat. No. 5,319,336 issued to Andrew R. Alcon, discloses a magnetic levitation system for a stable or rigid levitation of a body. The object to be levitated is maintained in an equilibrium position above a flat guideway or plurality of continuous guideways.

The prior art indicates that no levitation system has been developed with the capability to levitate on an uncharged and non-magnetized or arbitrary surface with the capability of horizontal motion.

### BRIEF DESCRIPTION OF THE DRAWINGS

FIG. 1a show a schematic of an embodiment of the levitation vehicle.

FIG. 1b is a schematic of another embodiment of the levitation vehicle.

FIG. 2a shows a schematic of a simple field plate assembly.

FIG. 2b is a schematic of a compound field plate assembly.

FIG. 2c is a sketch of a Halbach array field plate assembly.

FIG. 3a is a schematic of the simple feedback signal control.

FIG. 3b is a schematic of a compound feedback signal control.

FIG. 3c is a schematic of an alternate embodiment of the simple feedback signal control.

FIG. 3d is a schematic of an alternate embodiment of the compound feedback signal control.

FIG. 4 is a schematic of a high voltage transformer drive.

FIG. 5 is a schematic of a levitator drive unit.

FIG. 6 is a schematic of a circuit that the user controls in order to control the levitation vehicle.

FIG. A shows a block diagram of another embodiment of the levitation vehicle

FIG. B shows a schematic for the force feedback step-up transformer (FFST).

FIG. C1 shows a stack-up of conducting power plates for the levitation vehicle.

FIG. C2 illustrates a charging scheme for the conducting power plates.

FIG. D shows an alternate arrangement of a stack-up of conducting power plates.

FIG. E shows an alternate arrangement for the force feedback step-up transformer (FFST).

FIG. A0 (a, b, c) is a set of drawings that is used to illustrate the physics involved in dielectric polarization and its use to cause repulsion.

FIG. A1 is a schematic to illustrate the physical picture of a source of electric field that is causing dielectric polarization of the surface of levitation

FIG. A2 is a schematic to illustrate the physical picture involved in levitation through the use of dielectric polarization

### DETAILED DESCRIPTION OF THE DRAWINGS

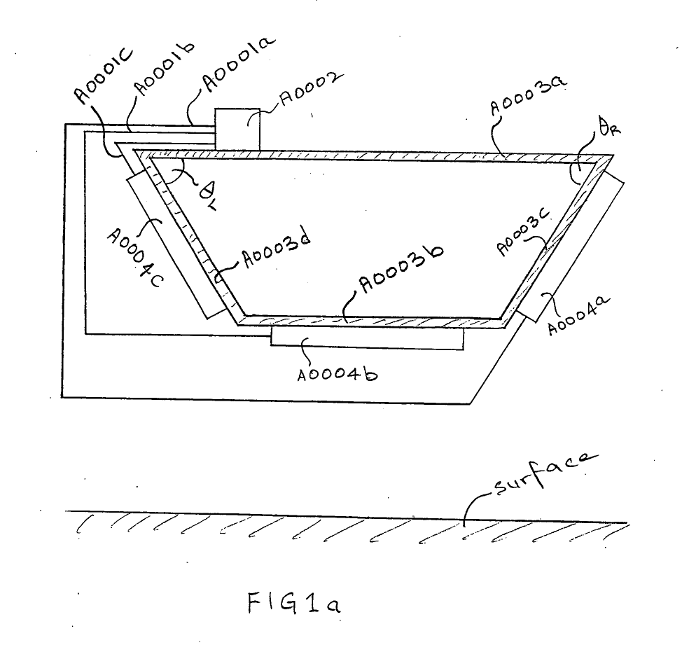

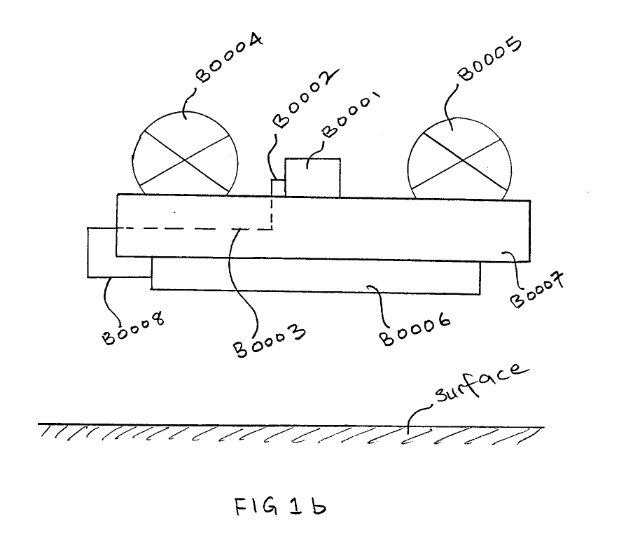

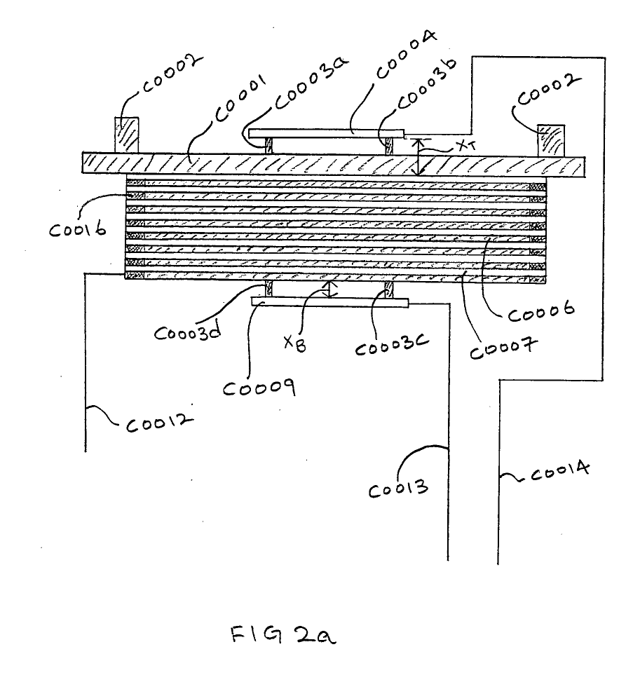

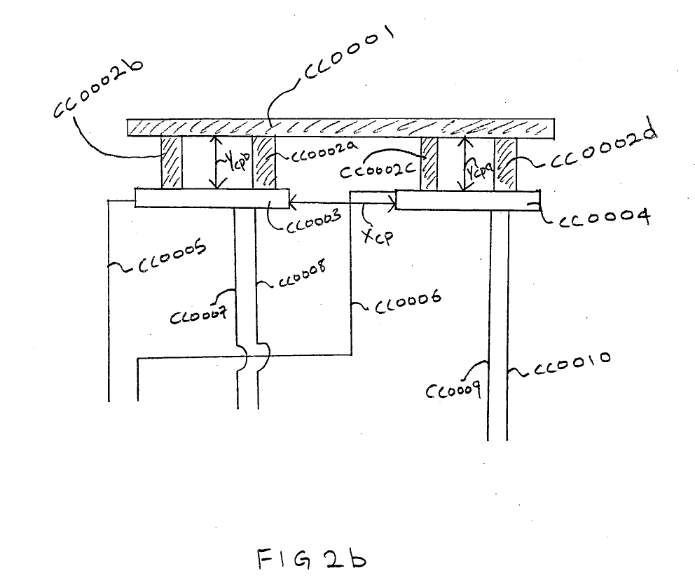

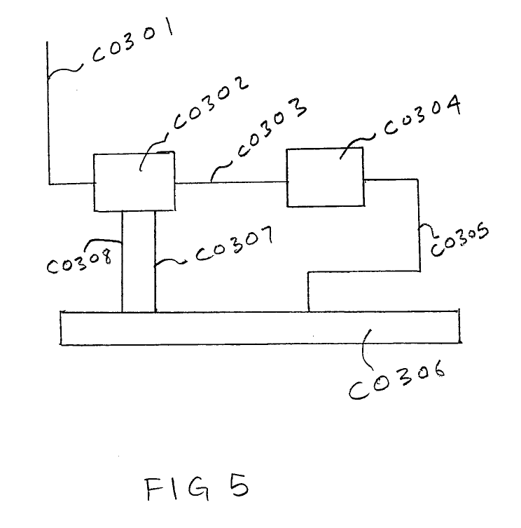

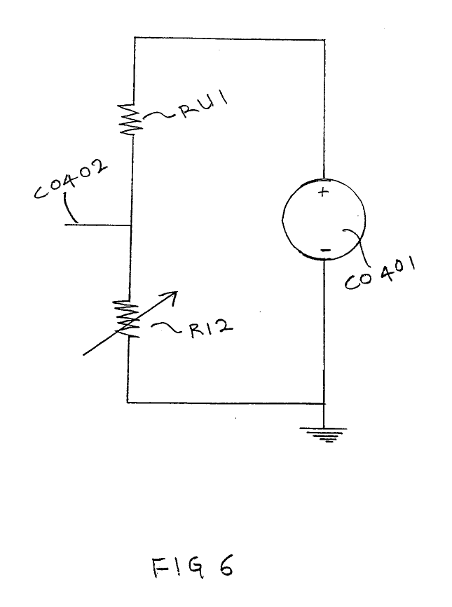

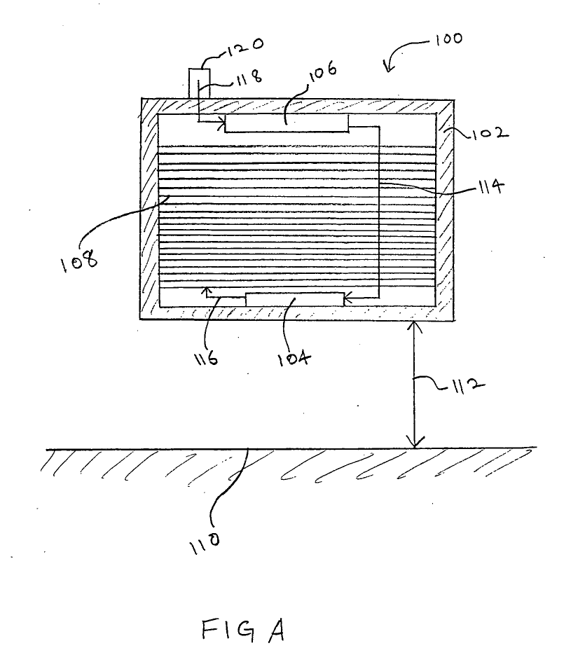

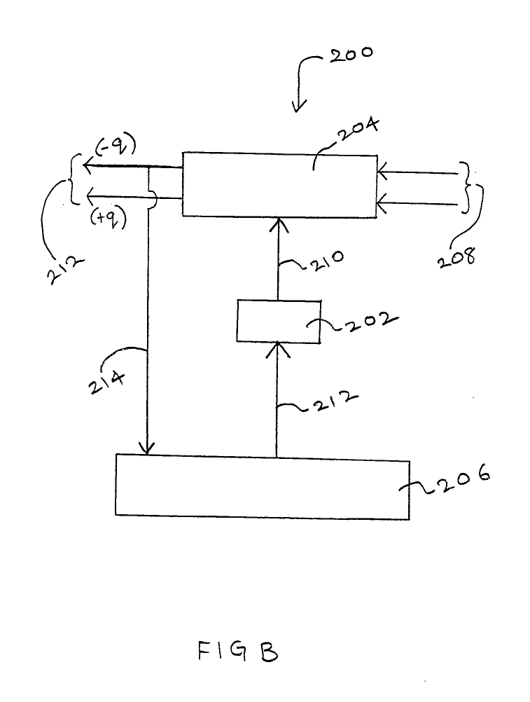

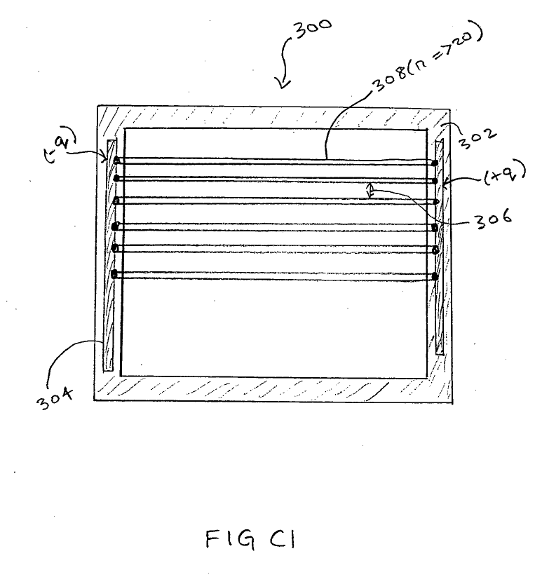

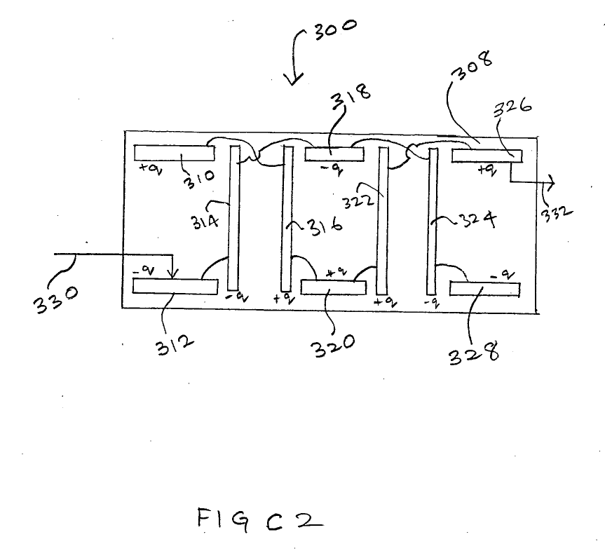

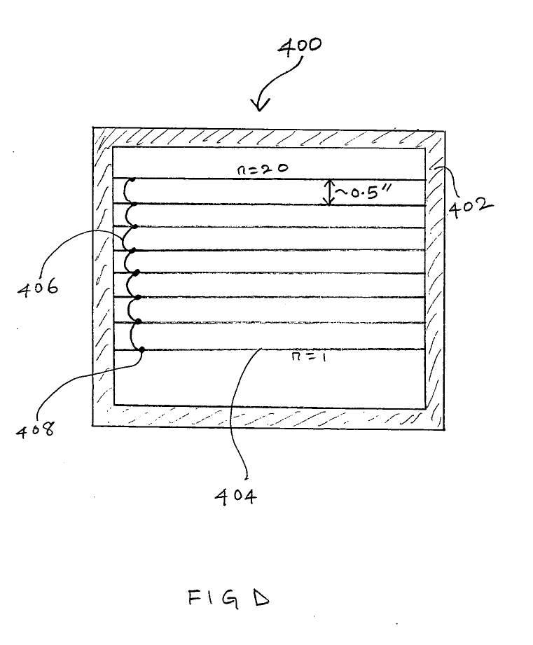

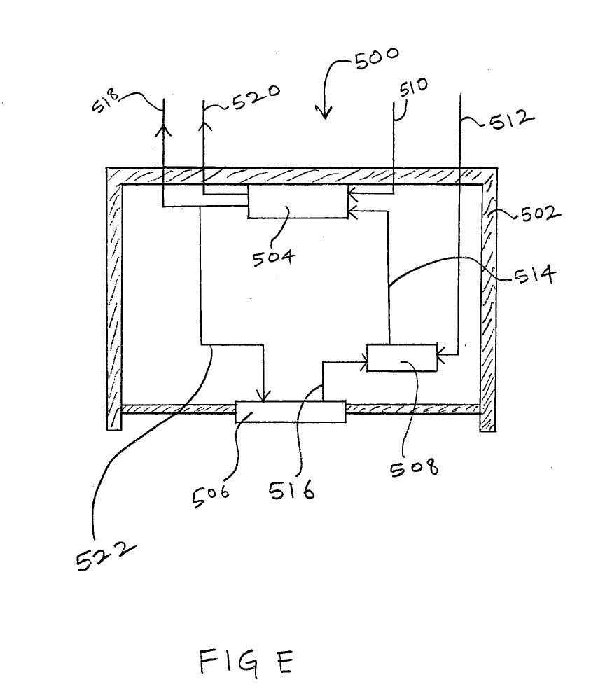

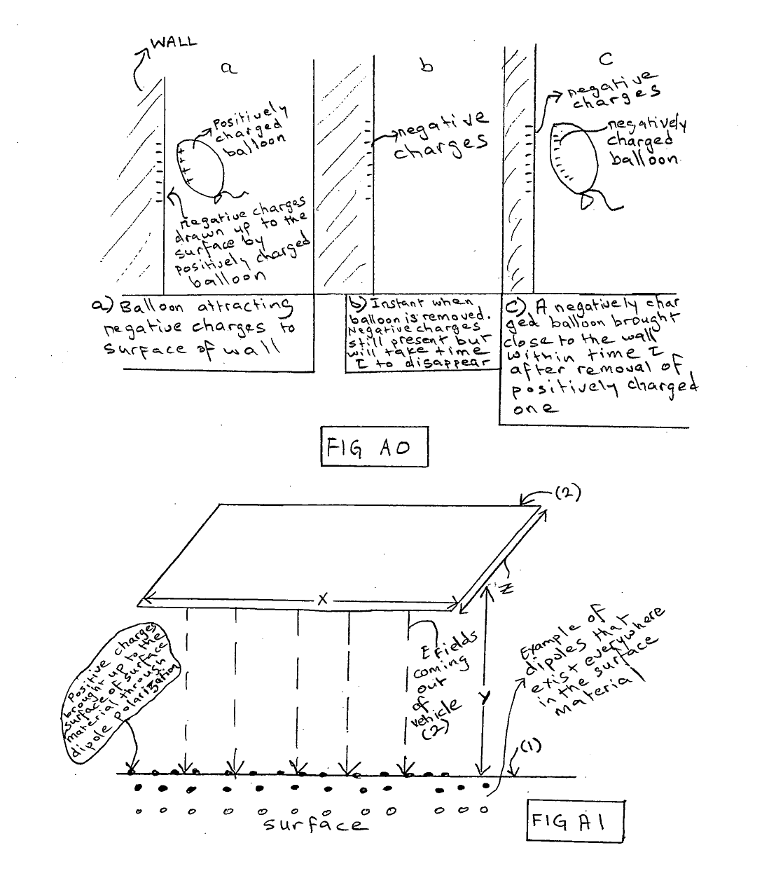

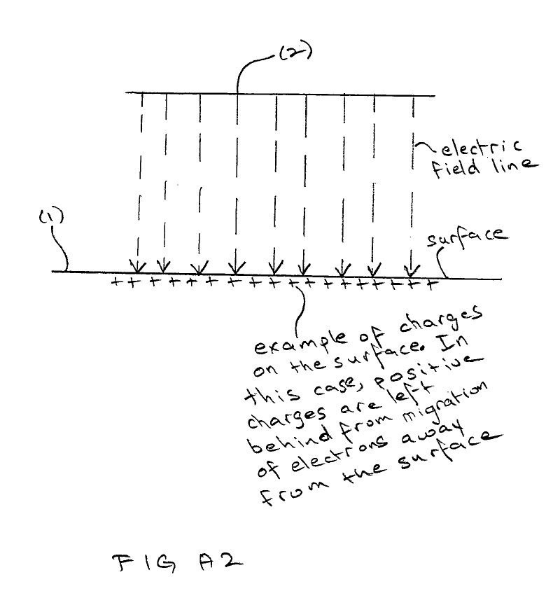

Referring now to FIG. 1a, FIG. 1a show a schematic of the levitation vehicle. The levitation vehicle comprises a chassis assembly (A0003a, A0003b, A0003c, A0003d). A0003a is the part of the chassis on which the user controls is placed. The user may also be positioned on top of A0003a to control the levitation vehicle through the use of the user control (A0002). A0003c is the part of the chassis that is inclined at an angle θ_{R} to (A0003a) as shown in FIG. 1a. (A0003d) is the part of the chassis that is inclined at an angle θ_{L} to (A0003a) as shown in FIG. 1a. A0003b is the part of the chassis that is closest to the surface (C0405) and joins (A0003c) and (A0003d) as shown in FIG. 1a. θ_{R}=(A0004a, A0004b, A0004c) are each levitator drive units as sketched in FIG. 5. A0004a is assembled on the part of the chassis (A0003c). The levitator drive unit is what causes repulsive forces between the surface (C0405) and the levitation vehicle. By positioning some of the levitation drive units at the depicted angles of θ_{L}, θ_{R} as shown in FIG. 1a, horizontal forces can also produced since it is inclined at an angle to the surface and thereby enables horizontal motion. (A0004c) and (A0004a) are positioned at such an incline to the surface as can be seen in FIG. 1a, thus horizontal motion is possible in different directions due to (A0004c) and (A0004a). More levitation drive units may also be attached to the levitation vehicle on different sides of the levitation vehicle depending on the desired direction of horizontal motion needed. For example, levitator drive units may also be placed at inclines of about 45° at two other sides to enable sideways motion, thus enabling the levitation vehicle to move in four different horizontal directions. (A0004b) is parallel to the surface and is responsible for most of the force that lifts the levitation vehicle. (A0001c, A0001b, A0001a) are conductive wire leads. Each of these wires is connected to a user control input like (C0301) in FIG. 5 where FIG. 5 is a more detailed schematic of a levitation drive unit. Each levitation drive unit should have a dedicated user control circuit. The user control circuit is depicted in FIG. 6. (A0002) is the user control station. The user control station is a unit that controls the output delivered to leads (A0001a, A0001b, A0001c). Each of the leads (A0001a, A0001b, A0001c) are connected to a dedicated user control output (C0402) of FIG. 6. For example, lead A0001a will be connected to a separate user control output (C0402) of a separate user control circuit. The user can then operate the vehicle by manipulating R_{U2} in the user control circuit shown in FIG. 6 of each of the corresponding leads (A0001a, A0001b, A0001c).

Referring now to FIG. 1b, FIG. 1b is an alternate embodiment of the levitation vehicle. The embodiment of the levitation vehicle depicted in FIG. 1b comprises a platform of chassis (B0007). (B0007) is a rigid, flat and non-metallic or is constituted of a material of low electric permittivity. (B0006) is a levitator drive unit. The levitator drive unit is depicted in detail in FIG. 5 (B0008) is the user control lead of the levitator drive unit (B0006). (B0008) can be passed through the chassis (B0007) as shown in the figure, comes out of the chassis (B0002) and is fed into the user control unit (B0001). (B0001) is the user control unit. Here the user can control the vehicle. (B0004, B0005) are propellers. These are also controlled from the user control unit. (B0004, B0005) can be used to propel the levitation unit in different directions by changing the direction of the propeller thrust.

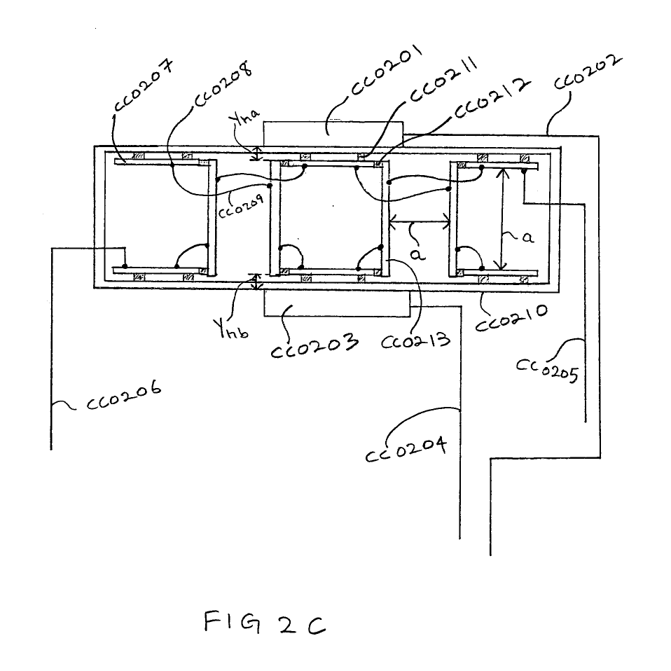

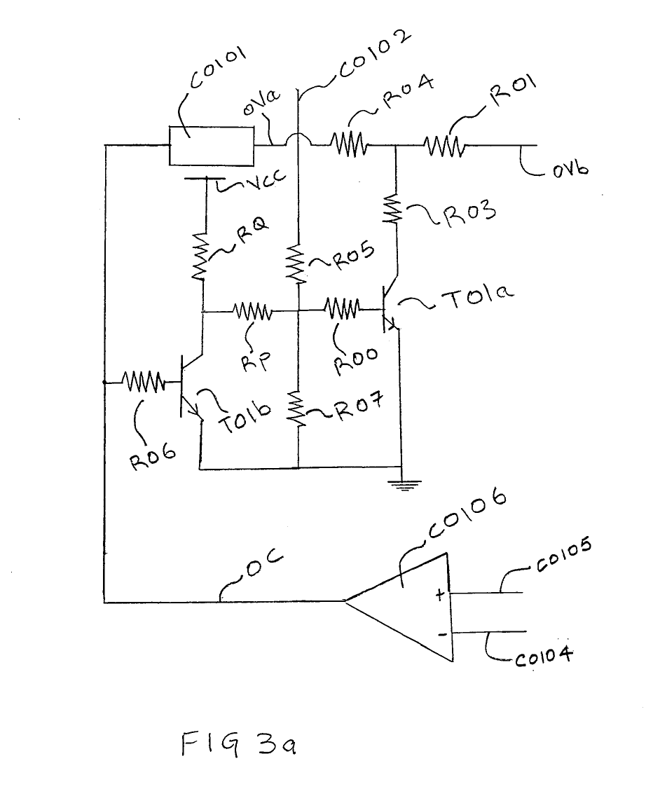

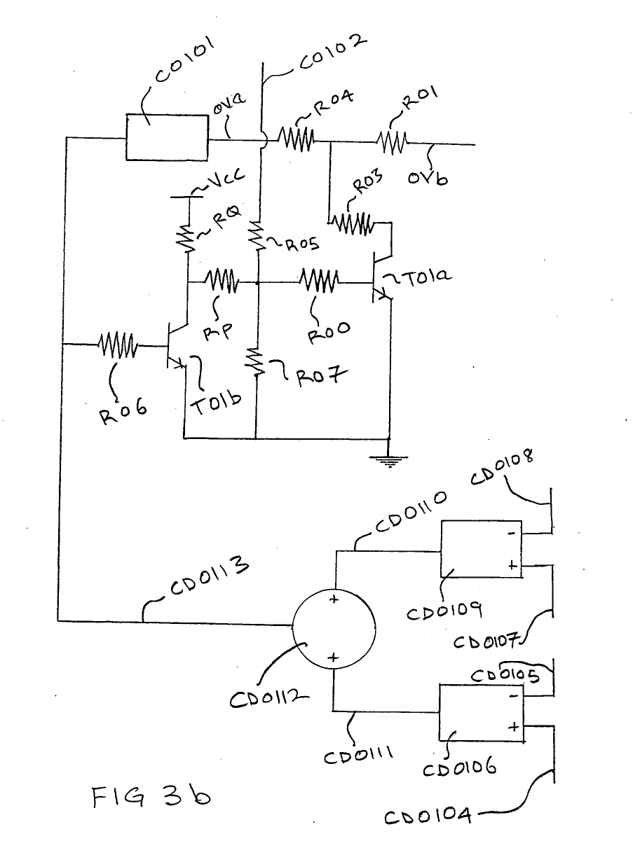

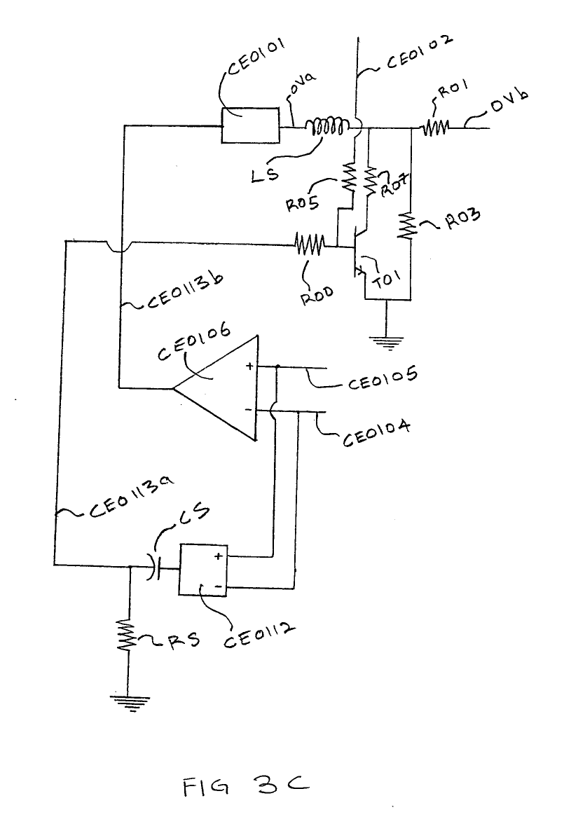

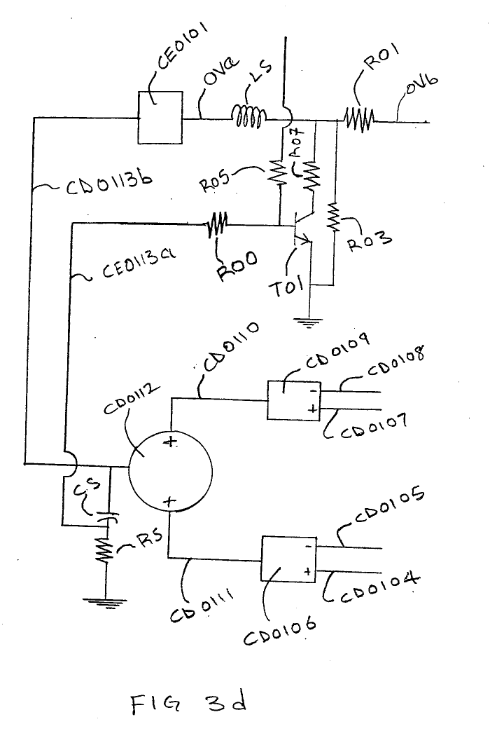

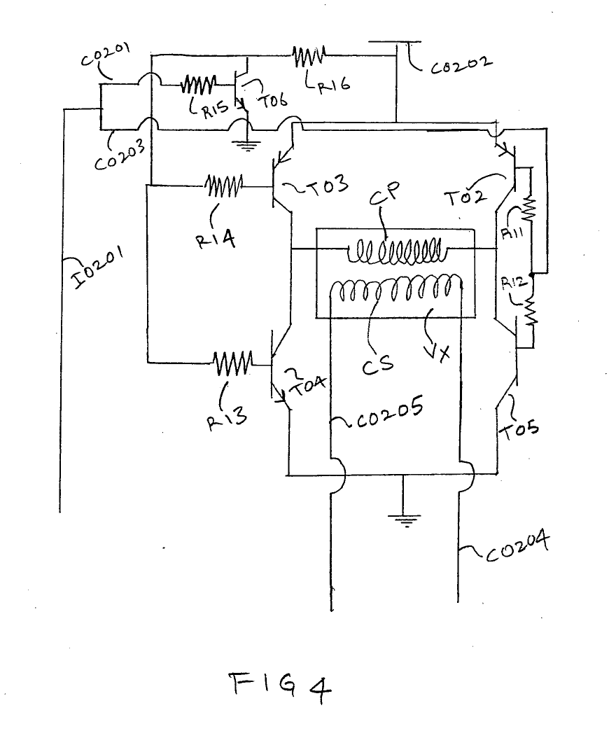

Referring now to FIG. 2a, FIG. 2a shows a schematic of a simple field plate assembly. A simple field plate assembly comprises conductive power plates (C0007). (C0007) is one of the array of conductive power plates that are shown in FIG. 2a. A conductive power plate is a flat metallic plate or foil that is about 20 square feet in area and is about 10 μm thick. The conductive power plate should be made as thin as possible so that is weighs as little as possible and as large in area as practical because wider conductive power plates will cause dielectric polarization in a larger area of the surface and therefore will cause the electric fields due to the dielectric polarization of the surface to reach up further away from the surface and therefore will enable greater levitation force on the levitation vehicle. About 100 of these conductive power plates are stacked one on top of the other with electrically insulating material (C0006) separating them. The insulating material like (C0006) can be made of a plastic sheet or a spray of electrically insulating coating like enamel. The insulating material (C0006) is any electrically non-conductive material. The thickness of the insulating material should be just thick enough to provide electric insulation between the area of the conductive power plates where the insulating material is placed but should not surpass such thickness in order to keep the weight of the levitation vehicle low. The insulating material should not extend over the entire area of a conductive power plate as shown in FIG. 2a. At an edge of the conductive power plates, metallic supports (C0016) are used to separate the power plates. These metallic supports (C0016) are used to electrically connect all of the conductive power plates together. Alternatively, the conductive power plates can be separated entirely by insulating material (C0006) and the conductive power plates (C0007) can be electrically connected together with electrical wires. (C0001) is the field plate assembly chassis. (C0001) is made of a rigid body which the assembly of the conductive power plates (C0007) and insulating material (C0006) is attached to. (C0002) are attachments screws that are used to attach the simple field plate assembly to external bodies. (C0004) is the top electrometer and (C0009) is the bottom electrometer. The bottom electrometer is attached to the side of the simple field plate assembly that is closest to the surface on which the levitation vehicle of FIG. 1a and FIG. 1b are levitated on. (C0004) and (C0009) are electrometers that are used to measure the magnitude of the electric fields in the region that the electrometer is located. (C0003a, C0003b, C0003c, C0003d) are supports for the electrometers (C0004, C0009). X_{T} is the clearance of the top electrometer from the top most conductive power plate while K_{B} is the clearance of the bottom electrometer from the bottom most conductive power plate. If the material between the top electrometer and the topmost conductive power plate is of the same dimensions and the same constitution as the material between the bottom electrometer and the bottom most conductive power plate then X_{T}=X_{B}. More generally, the bottom electrometer and the top electrometer should be adjusted in such a way that when the simple field plate assembly is very far away from any material body or when the field plate assembly is enclosed in a closed metallic enclosure where there are no sources of electric fields other than the conductive power plates, then the output from the top electrometer should be equal to or very close to the output from the bottom electrometer if the conductive power plates are charged by the high voltage transformer (Vx) that is shown in FIG. 4. A simple way to achieve this requirement is that X_{T}=X_{B} in addition to requiring any material between the top electrometer and the top most conductive power plate and the any material between the bottom electrometer and the bottom most conductive power plate to be of the same physical dimensions and the same constitution. This is necessary because the top electrometer reads the magnitude of the electric field at the top of the simple field plate assembly and the bottom electrometer reads the magnitude of the electric field at the bottom of the simple field plate assembly. (C0012) is the simple field plate assembly power lead made of electrical wire that is connected to one of the metallic supports, for example (C0016) and therefore is electrically connected to all the conductive power plates in the simple field plate assembly. The simple field plate assembly power lead (C0012) is connected to one output wire of the high voltage transformer (Vx) shown in FIG. 4 for example (C0204) or (C0205) shown in FIG. 4, thus enabling the assembly of conductive power plates to produce high electric fields from their surfaces. (C0014) is the output of the top electrometer. It goes into the input (C0105) of the comparator (C0106) shown in FIG. 3a or the input (CE0105) of the comparator (CE0106) shown in FIG. 3c while (C0013) is the output from the bottom electrometer (C0009). Output (C0013) of the bottom electrometer (C0009) goes into the input (C0104) of the comparator (C0106) shown in FIG. 3a or the input (CE0104) of the comparator (CE0106) shown in FIG. 3c. The top electrometer and the bottom electrometer are used to measure the force on the simple field plate assembly due to the dielectric polarization that was induced on the surface by the simple field plate assembly by measuring the magnitude of the electric field in the vicinity of the top electrometer and the bottom electrometer. The bottom electrometer (C0009) is closest to the surface of levitation, so if a repulsive force acts between the surface of levitation and the simple field plate assembly due to the induced dielectric polarization of the surface on which the simple field plate assembly is levitated on, then the magnitude of the electric field in the vicinity of the bottom electrometer (C0009) will be less than the magnitude of the electric field in the vicinity of the top electrometer (C0004). If an attractive force acts on the simple field plate assembly due to the induced dielectric polarization on which the simple field plate assembly is levitated on, then the magnitude of the electric field in the vicinity of the bottom electrometer (C0009) will be greater than the magnitude of the electric field in the vicinity of the top electrometer (C0004).

Referring now to FIG. 2b, FIG. 2b is a schematic of a compound field plate assembly. A compound field plate assembly comprises simple field plates (CC0003, CC0004). The simple field plate assembly power lead (CC0005) of simple field plate assembly (CC0003) is connected to one lead of transformer Vx shown in FIG. 4, for example (CC0005) may be connected to the lead (C0204) of the transformer Vx which is depicted in FIG. 4 and the simple field plate assembly power lead (CC0006) of simple field plate assembly (CC0004) is connected to the other lead of transformer Vx shown in FIG. 4, for example if simple field plate assembly power lead (CC0005) is connected to (C0204) then (CC0006) should be connected to (C0205). (CC0007) is the output from the bottom electrometer of simple field plate assembly (CC0003). (CC0008) is the output from the top electrometer of simple field plate assembly (CC0003). Bottom electrometer output (CC0007) is connected to input (CD0108) of subtractor (CD0109) in FIG. 3b. Top electrometer output (CC0008) is connected to input (CD0107) of subtractor (CD0109) in FIG. 3b. (CC0009) is the output from the bottom electrometer of simple field plate assembly (CC0004). (CC0010) is the output from the top electrometer of simple field plate assembly (CC0004). Bottom electrometer output (CC0009) is connected to input (CD0105) of subtractor (CD0106) shown in FIG. 3b. Top electrometer output (CC0010) is connected to the input (CD0104) of subtractor (CD0106) shown in FIG. 3b. The subtractor (CD0109) subtracts the output of bottom electrometer of (CC0003) from the output of the top electrometer of (CC0003). The subtractor (CD0106) subtracts the output of the bottom electrometer of (CC0004) from the output of the top electrometer of (CC0004). The output of (CD0109) and (CD0106) is added by adder (CD0112) and thus the output of adder (CD0112) indicates the nature of the force that is acting on the compound field plate assembly due to the induced dipole polarization of the surface on which the levitation vehicle is being levitated on. X_{CP} is the physical separation of the simple field plate assembly (CC0003) and (CC0004). X_{CP} should be about 6 feet, more generally X_{CP} should be about the same as the dimensions of the simple field plate assembly. (CC0001) is the metallic shield plate. The purpose of (CC0001) is to minimize the appearance of electric fields above the metallic shield plate. The metallic shield plate can be a simple aluminum foil that spans the area of the compound field plate assembly. (CC0002a, CC0002b, CC0002c, CC0002d) are physical supports that position the metallic shield plate (CC0001) at a clearance Y_{CPA}, Y_{CPB} from the simple field plate assembly (CC0003, CC0004) as shown in FIG. 2b. Y_{CPA}=Y_{CPB} and they should be about 5 feet, more generally Y_{CPA}, Y_{CPB} should be about the same as the dimensions of the simple field plate assembly.

Referring now to FIG. 2c, FIG. 2c is a sketch of a Halbach array field plate assembly. The Halbach array field plate assembly is the electrostatic version of the popular magnetic Halbach array. (CC0207) is one of an array of horizontal metal field plates as shown in FIG. 2c. These horizontal metal field plates are arranged as shown in the figure. The surface area of (CC0207) is about 25 square inches. (CC0208) one of the electrical connections between the vertical metal field plates, for example (CC0213) and the horizontal metal field plates for example (CC0207) and electrical wires for example (CC0209). The vertical metal field plates and the horizontal metal field plates are connected as shown in FIG. 2c. (CC0211) is one of the physical supports to attach the horizontal metal field plates to the chassis (CC0210). (CC0211) are made out of electrical insulators. (CC0210) is a physically rigid enclosure that is made out of an electrical insulator material or a material of low electrical permeability. (CC0209) is one of the electrical wires shown in FIG. 2c. Electrical wires like (CC0209) are used to connect the vertical metal field plates and the horizontal metal field plates in such a way that they form the electric analogue of a Halbach array. (CC0213) is one of an array of vertical metal field plates as shown in FIG. 2c. These are metal plates of about 25 square inches in area. (CC0212) are one of an array of physical supports for the vertical metallic field plates as shown in FIG. 2c. (CC0212) are made out of an electrical insulator. The supports for the vertical metal field plates like (CC0212) are used to attach the vertical metal field plates to the horizontal metal field plates. (CC0206) is one power input into the Halbach array field plate assembly. (CC0206) should be connected to one output of the transformer Vx shown in FIG. 4. For example (CC0206) in FIG. 2c can be connected to (C0204) in FIG. 4 (CC0205) is one power input into the Halbach array field plate assembly. (CC0205) should be connected to the output of the transformer (Vx) shown in FIG. 4 that (CC0206) of FIG. 2c is not connected to. For example if (CC0206) in FIG. 2c is connected to (C0204) in FIG. 4, then (CC0205) in FIG. 2c should be connected to (C0205) in FIG. 4. (CC0201) is the top electrometer of the Halbach array field plate assembly and (CC0203) is the bottom electrometer of the Halbach array field plate assembly. (CC0202) is the output from the top electrometer (CC0201). (CC0202) is connected to (C0105) of FIG. 3a or (CE0105) of FIG. 3c. (CC0204) is the output of the bottom electrometer (CC0203). (CC0204) is connected to (C0104) of FIG. 3a or (CE0104) of FIG. 3c. The electrometers (CC0201, CC0203) are used to measure the magnitude of the electric field in their respective vicinities. The electrometers should be adjusted in such a way that when the Halbach array field plate assembly is far from a material body and (CC0205,CC0206) is charged by transformer (Vx) that is depicted in FIG. 4 that the output of both the bottom electrometer and the top electrometer of the Halbach array field plate assembly should be close. A plurality of Halbach array field plate assembly should be placed side by side so that the total area that is covered by the assembly of Halbach array field plate assemblies should be around 25 square feet and additionally, the arrangement of these Halbach array field plate assembly should be stacked one on top of the other if more repulsive force is desired. The Halbach array field plate assembly enables higher electric fields at the bottom of the Halbach array field plate assembly and lower electric fields at the top of the Halbach array field plate assembly.

Referring now to FIG. 3a, FIG. 3a is a schematic of the simple feedback signal control. The simple feedback signal control comprises a comparator (C0106) with inputs (C0105) and (C0104) as shown in FIG. 3a. (C0106) can be an operational amplifier. The simple feedback signal control can either be used with the simple field plate assembly or with the Halbach array field plate assembly. The output from the top electrometer of either the simple field plate assembly of FIG. 2a or the Halbach array field plate assembly of FIG. 2c is connected to (C0105) of FIG. 3a. The output from the bottom electrometer of either the simple field plate assembly of FIG. 2a or of the Halbach array field plate assembly of FIG. 2c is connected to (C0104) of FIG. 3a. Thus if the magnitude of the electric field in the vicinity of the top electrometer is higher than the magnitude of the electric field in the vicinity of the bottom electrometer of either the simple field plate assembly of FIG. 2a or the Halbach array field plate of FIG. 2c, then the comparator (C0106) registers a high voltage at its output (OC). If the magnitude of the electric field in the vicinity of the top electrometer is lower than or equal to the magnitude of the electric field in the vicinity of the bottom electrometer of either the simple field plate assembly of FIG. 2a or the Halbach array field plate of FIG. 2c, then the comparator (C0106) registers a low voltage at its output (OC). If a repulsive force acts on the simple field plate assembly or the Halbach array field plate assembly due to the induced dipole polarization of the surface, then the magnitude of the electric field in the vicinity of the top electrometer will be higher than the magnitude of the electric field in the vicinity of the bottom electrometer and the comparator will indicate this with an output of high voltage. If an attractive or a neutral force acts on the simple field plate assembly or Halbach array field plate assembly due to the induced dielectric polarization of the surface, then the magnitude of the electric field in the vicinity of the top electrometer will be lower than or equal to the magnitude of the electric field in the vicinity of the bottom electrometer and the comparator will indicate this as a low voltage at its output (OC). The output from the comparator is fed into the voltage controlled oscillator (C0101). The voltage controlled oscillator should be of such a type that if the input to the frequency control of the voltage controlled oscillator (C0101) is high that the frequency of the output of the voltage controlled oscillator should be low and if the input to the frequency control of the voltage controlled oscillator (C0101) is low that the frequency of the output of the voltage controlled oscillator should be high. Note that if a voltage controlled oscillator which outputs high frequency if the input to the frequency control is high and outputs a low frequency if the input to its frequency control is low, then a signal inverter should be placed between the output of (C0106) and the input to the frequency control of the voltage controlled oscillator. Alternatively (C0104) should be fed into the input that is depicted to be fed by (C0105) and (C0105) should be fed into the input that is depicted to be fed by (C0104) in FIG. 3a. The voltage controlled oscillator must also be the type that outputs sinusoidal signals. Such voltage controlled oscillators are readily available in the market. The value of the low frequency output of the voltage controlled oscillator (C0101) should be adjusted to produce maximum levitation force on the levitation vehicle. This can be done by adjusting the voltage of the low output of the comparator (C0106). Also the value of the high frequency output of the voltage controlled oscillator (C0101) should be adjusted to such a value as to give the maximum levitation force on the levitation vehicle. This can be done by adjusting the voltage of the high output of the comparator (C0106). The output of the voltage controlled oscillator has to be fed into the high voltage transformer drive of FIG. 4, but it needs to be processed so that the output from the transformer Vx in FIG. 4 has the same magnitude regardless of the frequency of the output of the voltage controlled oscillator (C0101) or the output (OVa) may be processed so that the magnitude of the output of the transformer is lower when the frequency of the output (Ova) is high. The circuit composed of (R04,RP,RQ,R06,R00,R07,T01a,T01b,R03,R01) is the electronic system that provides the necessary processing of the output (Ova). When the frequency of the output Ova is high, transistor T01a is turned on and the magnitude of the output Ovb is lowered by the voltage divider formed by R04 and R03. When the frequency of the output Ova is low, transistor T01a is turned off and the magnitude of the output OVb is held equal to the output Ova. The output Ovb is connected to the input 10201 of FIG. 4. (C0102) is a lead to allow the user to control the simple feedback signal control and thus the levitation vehicle. Alternatively the entire simple feedback signal control of FIG. 3a may be programmed on a microcontroller. The reason why the voltage controlled oscillator should output low frequency when the levitation vehicle is being acted on by a repulsive force and a high frequency when the levitation vehicle is being acted on by an attractive or neutral force is the following: The polarity of output of transformer Vx in FIG. 4 will depend on whether the output (OVb) is rising or falling henceforth referred to the changing state of (OVb). If repulsive force is acting on the levitation vehicle, then it means that the dielectric polarization of the surface on which the levitation vehicle is being levitated on and the changing state of (OVb) are such that they cause repulsive force on the levitation vehicle. In this case, the frequency of the voltage controlled oscillator should remain low if it was initially low or should be made low if it was initially at high in order to maintain the changing state of (OVb) which causes levitation. If attractive or neutral force is acting on the levitation vehicle, then it means that the dielectric polarization of the surface on which the levitation vehicle is being levitated on and the changing state of (OVb) are such that they cause attractive force or no force on the levitation vehicle. In this case, the frequency of the voltage controlled oscillator should remain high if it was initially high or should be made high if it was initially low in order to change the changing state of (OVb) to a state that will cause repulsion on the levitation vehicle. Thus the levitation vehicle spends much more time for any given time interval in a state of repulsion between the levitation vehicle and the surface and thus the levitation vehicle stays levitated. Possible values for the resistors are (R01=1k, R04=1k, R03=100, R00=1k, R07=10k, R05=10k, RP=10k, RQ=1k, R06=10k) but a variety of different values of the resistors are possible.

Referring now to FIG. 3b, FIG. 3b is a schematic of a compound feedback signal control which is to be used for the compound field plate assembly shown in FIG. 2b. (CD0109, CD0106) are subtractors. (CD0109) subtracts the output of the bottom electrometer from the output of the top electrometer of one of the simple field plates in the compound field plate and (CD0106) subtracts the output of the bottom electrometer from the output of the top electrometer of the other simple field plate in the compound field plate assembly. The output of (CD0109) and (CD0106) are fed into an adder (CD0112) which adds the output of the two subtractors (CD0109, CD0106). Thus if a repulsive force acts on the compound field plate assembly due to the induced dielectric polarization on the surface then the output from the adder (CD0113) registers a high voltage and if an attractive force or no force acts on the compound field plate assembly due to the induced dielectric polarization on the surface then the output from the adder (CD0113) registers a low voltage. The output from the adder (CD0112) is fed into the voltage controlled oscillator (C0101). The voltage controlled oscillator should be of such a type that if the input to the frequency control of the voltage controlled oscillator (C0101) is high that the frequency of the output of the voltage controlled oscillator should be low and if the input to the frequency control of the voltage controlled oscillator (C0101) is low that the frequency of the output of the voltage controlled oscillator should be high. The voltage controlled oscillator must also be the type that outputs sinusoidal signals. Such voltage controlled oscillators are readily available in the market. The value of the low frequency output of the voltage controlled oscillator (C0101) should be adjusted to produce maximum levitation force on the levitation vehicle. This can be done by adjusting the voltage of the high output of the comparator (C0106). Also the value of the high frequency output of the voltage controlled oscillator (C0101) should be adjusted to such a value as to give the maximum levitation force on the levitation vehicle. This can be done by adjusting the voltage of the high output of the comparator (C0106). The output of the voltage controlled oscillator has to be fed into the high voltage transformer drive of FIG. 4, but it needs to be processed so that the output from the transformer Vx in FIG. 4 has the same magnitude regardless of the frequency of the output of the voltage controlled oscillator (C0101) or the output (OVa) may be processed so that the magnitude of the output of the transformer is lower when the frequency of the output (Ova) is high. The circuit composed of (R04,RP,RQ,R06,R00,R07,T01a,T01b,R03,R01) is the electronic system that provides the necessary processing of the output (Ova). When the frequency of the output Ova is high, transistor T01a is turned on and the magnitude of the output Ovb is lowered by the voltage divider formed by R04 and R03. When the frequency of the output Ova is low, transistor T01a is turned off and the magnitude of the output OVb is held equal to the output Ova. The output Ovb is connected to the input 10201 of FIG. 4. (C0102) is a lead to allow the user to control the simple feedback signal control and thus the levitation vehicle. Alternatively the entire compound feedback signal control of FIG. 3b may be programmed on a microcontroller. The reason why the voltage controlled oscillator should output low frequency when the levitation vehicle is being acted on by a repulsive force and a high frequency when the levitation vehicle is being acted on by an attractive or neutral force is the following: The polarity of output of transformer Vx in FIG. 4 will depend on whether the output (OVb) is rising or falling henceforth referred to the changing state of (OVb). If repulsive force is acting on the levitation vehicle, then it means that the dielectric polarization of the surface on which the levitation vehicle is being levitated on and the changing state of (OVb) are such that they cause repulsive force on the levitation vehicle. In this case, the frequency of the voltage controlled oscillator should remain low if it was initially low or should be made low if it was initially at high in order to maintain the changing state of (OVb) which causes levitation. If attractive or neutral force is acting on the levitation vehicle, then it means that the dielectric polarization of the surface on which the levitation vehicle is being levitated on and the changing state of (OVb) are such that they cause attractive force or no force on the levitation vehicle. In this case, the frequency of the voltage controlled oscillator should remain high if it was initially high or should be made high if it was initially low in order to change the changing state of (OVb) to a state that will cause repulsion on the levitation vehicle. Thus the levitation vehicle spends much more time for a given time interval in a state of repulsion between the levitation vehicle and the surface and thus the levitation vehicle stays levitated. Possible values for the resistors are (R01=1k, R04=1k, R03=100, R00=1k, R07=10k, R05=10k, RP=10k, RQ=1k, R06=10k) but a variety of different values of the resistors are possible.

Referring now to FIG. 3c, FIG. 3c is a schematic of an alternate embodiment of the simple feedback signal control. The alternate embodiment of the simple feedback signal control comprises a comparator (CE0106). The comparator (CE0106) indicates whether the magnitude of the electric field in the vicinity of the top electrometer is higher than the magnitude of the electric field in the vicinity of the bottom electrometer with an output of high which is delivered to lead (CE0113b). The output of the top electrometer of either the simple field plate assembly or the Halbach array field plate assembly is connected to (CE0105). The output of the bottom electrometer of either the simple field plate assembly or the Halbach array field plate assembly is connected to (CE0104). The output of the comparator (CE0106) is connected to the input of the voltage controlled oscillator (CE0101) that controls the frequency of the output of the voltage controlled oscillator. The voltage controlled oscillator is the type that outputs sinusoidal signals. The voltage controlled oscillator (CE0101) is the type that outputs a low frequency when the input to its frequency control is high and a high frequency when the input to its frequency control is low. (LS) is an inductor. The impedance of (LS) is high when the frequency of the output of the voltage controlled oscillator is high and the impedance of (LS) is low when the frequency of the output of the voltage controlled oscillator is low. Thus the voltage divider that is formed by (LS, R03) makes the magnitude of the output from the transformer Vx in FIG. 4 to have less dependence on the frequency of the output of the voltage controlled oscillator (OVa). (CE0112) is a subtractor. (CE0112) subtracts the output of the bottom electrometer from the output of the top electrometer. The output of (CE0112) is fed into the base of transistor (T01) through capacitor (CS). If the dielectric polarization of the surface is increasing and the dielectric polarization of the surface has the polarity that repels the levitation vehicle from the surface, then the output of (CE0112) will be increasing and thus a current will be able to pass out of (CE0112) through the capacitor (CS) and into the base of transistor (T01). This will make the magnitude of output (OVb) lower. If the dielectric polarization of the surface is decreasing and the dielectric polarization of the surface has the polarity that repels the levitation vehicle from the surface, then the output of (CE0112) will be decreasing and thus a current will be going into (CE0112) through capacitor (CS) and thus the transistor (T01) will act as an open switch and the magnitude of output OVb will be higher. Thus the action of (CE0112, CS, T01) is seen to produce higher magnitude of electric field from either the simple field plate assembly or the Halbach field plate assembly when the dielectric polarization of the surface is decreasing. In this method, the magnitude of the dielectric polarization of the surface can be increased and thus giving rise to greater repulsive force on the levitation vehicle, in particular the action of (CE0112, CS, T01) implements the resonance delivery algorithm. The reason why the voltage controlled oscillator should output low frequency when the levitation vehicle is being acted on by a repulsive force and a high frequency when the levitation vehicle is being acted on by an attractive or neutral force is the following: The polarity of output of transformer (Vx) in FIG. 4 will depend on whether the output (OVb) is rising or falling henceforth referred to the changing state of (OVb). If repulsive force is acting on the levitation vehicle, then it means that the dielectric polarization of the surface on which the levitation vehicle is being levitated on and the changing state of (OVb) are such that they cause repulsive force on the levitation vehicle. In this case, the frequency of the voltage controlled oscillator should remain low if it was initially low or should be made low if it was initially at high in order to maintain the changing state of (OVb) which causes levitation. If attractive or neutral force is acting on the levitation vehicle, then it means that the dielectric polarization of the surface on which the levitation vehicle is being levitated on and the changing state of (OVb) are such that they cause attractive force or no force on the levitation vehicle. In this case, the frequency of the voltage controlled oscillator should remain high if it was initially high or should be made high if it was initially low in order to change the changing state of (OVb) to a state that will cause repulsion on the levitation vehicle. Thus the levitation vehicle spends much more time for a given time interval in a state of repulsion between the levitation vehicle and the surface and thus the levitation vehicle stays levitated.

Referring now to FIG. 3d, FIG. 3d is a schematic of an alternate embodiment of the compound feedback signal control. The alternate embodiment of the compound feedback signal control comprises subtractors (CD0109, CD0106). (CD0109) subtracts the output of the bottom electrometer from the output of the top electrometer of one of the simple field plates in the compound field plate and (CD0106) subtracts the output of the bottom electrometer from the output of the top electrometer of the other simple field plate in the compound field plate assembly. The output of (CD0109) and (CD0106) are fed into an adder (CD0112) which adds the output of the two subtractors (CD0109, CD0106). Thus if a repulsive force acts on the compound field plate assembly due to the induced dielectric polarization on the surface then the output from the adder (CD0113b) registers a high voltage and if an attractive force or no force acts on the compound field plate assembly due to the induced dielectric polarization on the surface then the output from the adder (CD0113b) registers a low voltage. The output from the adder (CD0112) is fed into the voltage controlled oscillator (CE0101). The voltage controlled oscillator should be of such a type that if the input to the frequency control of the voltage controlled oscillator (CE0101) is high that the frequency of the output of the voltage controlled oscillator should be low and if the input to the frequency control of the voltage controlled oscillator (C0101) is low that the frequency of the output of the voltage controlled oscillator should be high. The voltage controlled oscillator (CE0101) should also be the type that outputs sinusoidal signals. (LS) is an inductor. The impedance of (LS) is high when the frequency of the output of the voltage controlled oscillator is high and the impedance of (LS) is low when the frequency of the output of the voltage controlled oscillator is low. Thus the voltage divider that is formed by (LS, R03) makes the magnitude of the output from the transformer Vx in FIG. 4 to have less dependence on the frequency of the output of the voltage controlled oscillator (OVa). The output of (CD0112) is fed into the base of transistor (T01) through capacitor (CS). If the dielectric polarization of the surface is increasing and the dielectric polarization of the surface has the polarity that repels the levitation vehicle from the surface, then the output of (CD0112) will be increasing and thus a current will be able to pass out of (CD0112) through the capacitor (CS) and into the base of transistor (T01). This will make the magnitude of output (OVb) lower. If the dielectric polarization of the surface is decreasing and the dielectric polarization of the surface has the polarity that repels the levitation vehicle from the surface, then the output of (CD0112) will be decreasing and thus a current will be going into (CE0112) through capacitor (CS) and thus the transistor (T01) will act as an open switch and the magnitude of output OVb will be higher. Thus the action of (CD0112, CS, T01) is seen to produce higher magnitude of electric field from either the simple field plate assembly or the Halbach field plate assembly when the dielectric polarization of the surface is decreasing. In this method, the magnitude of the dielectric polarization of the surface can be increased and thus giving rise to greater repulsive force on the levitation vehicle, in particular the action of (CD0112, CS, T01) implements the resonance delivery algorithm.

Referring now to FIG. 4, FIG. 4 is a schematic of a high voltage transformer drive. This is used to drive a high voltage step-up transformer (Vx). A simple example of a high voltage transformer drive is a H-bridge. A H-bridge driver is a common electronic device and comes in wide variety. FIG. 4 is an illustration of how to use the H-bridge driver in the levitation vehicle disclosed in this patent application. (I0201) is the input to the H-bridge which receives the output of either the simple feedback signal control (OVb) or the output of the compound feedback signal control OVb. Circuit components (R16,T06,R15) is used to control transistors (T03,T04) while input (C0203) is used to control transistors (T02,T05). In the usual H-bridge configuration, a sinusoidal current is developed in the primary coil of the high voltage step-up transformer (Vx). The voltage of the sinusoidal signal from the output of the simple feedback signal control or the compound feedback signal control is thus multiplied by the transformer (Vx). The voltage output from the transformer (Vx) should be high enough to cause levitation of the levitation vehicle but should not be higher than the voltage required to cause the levitation vehicle to produce electric fields of more than 3MV/m although in some environments this limit can be relaxed.

Referring now to FIG. 5, FIG. 5 is a schematic of a levitator drive unit. The levitator drive unit comprises of a unit (C0306). (C0306) can either be a simple field plate assembly, a compound field plate assembly or a Halbach array field plate assembly. (C0304) is the high voltage transformer drive. (C0305) connects the transformer (Vx) shown in FIG. 4 to unit (C0306). If (C0306) is a compound field plate assembly or a Halbach array field plate assembly, then (C0305) comprises two leads that are connected to the two leads of the output (C0204, C0205) of transformer (Vx). If (C0306) is a simple field plate assembly, then (C0305) comprises a single lead that is connected to one of the leads of the output of transformer (Vx). (C0305) is connected to (C0012) of FIG. 2a if unit (C0306) is a simple field plate assembly. (C0305) comprises 2 leads that are connected to (CC0005, CC0006) of FIG. 2b if unit (C0306) is a compound field plate assembly. (C0305) comprises 2 leads that are connected to (CC0206, CC0205) of FIG. 2c if unit (C0306) is a Halbach array field plate assembly. (C0303) is a lead that is connected to (I0201) of the high voltage transformer drive shown in FIG. 4. (C0303) is also connected to (OVb) in either the simple feedback signal control of FIG. 3a or FIG. 3c or (OVb) of the compound feedback signal control of FIG. 3b depending on which embodiment of unit (C0306) is used and which embodiment of the simple feedback signal control (FIG. 3a, FIG. 3c) is used. (C0302) is either the simple feedback signal control of (FIG. 3a, FIG. 3c) or (C0302) is the compound feedback control of FIG. 3b. (C0301) is the user control signal. (C0301) is connected to (C0402) of FIG. 6. (C0308, C0307) are the outputs of the top electrometer and bottom electrometer of unit (C0306). If unit (C0306) is a simple field plate assembly or a Halbach array field plate assembly then (C0308, C0307) each comprise single wires where one of (C0307,C0308) is the output of the top electrometer and the other of (C0307, C0308) is the output of the bottom electrometer. If unit (C0306) is a compound field plate assembly then (C0308) is composed of 2 leads and (C0307) is composed of 2 leads where (C0308) can be the outputs of the 2 top electrometers and (C0307) can be the outputs of the 2 bottom electrometers.

Referring now to FIG. 6, FIG. 6 is a schematic of a circuit that the user controls in order to control the levitation vehicle. The user input is made through the manipulation of a variable resistor (Ru2). Thus the voltage divider formed by resistors (Ru1,Ru2) divides the voltage of the voltage source (C0401). The output (C0402) is fed into either input (C0102) of FIG. 3b or (C0102) of FIG. 3a or (CE0102) of FIG. 3c depending on which embodiment of the simple field plate assembly, the compound field plate assembly or the Halbach array field plate assembly is used and which embodiment of the simple feedback signal control (FIG. 3a, FIG. 3c) is used.

Referring now to FIG. A, FIG. A shows a block diagram of an electromagnetic levitation device 100. The device 100 comprises a chassis 102, which houses the device 100. A force feedback step-up transformer (FFST) 104. The FFST 104 controls a high frequency high voltage power source (HFHV) 106, a stack of power plates 108. The HFHV has frequency, which is controlled by the FFST 106. The HFHV 106 transmits power to the stack of power plates 108. The stack of power plates 108 generates an electric field. The FFST 104 controls the frequency of the electric field from the stack of conductive power plates 108 in such a manner that the device 100 remains levitated from the uncharged and non-magnetized arbitrary surface 110. The levitation height between the chassis 102 and the uncharged and non-magnetized arbitrary surface can be about 5 feet. The lead to primary coil in from HFHV 106 to FFST 104 is shown by a connection lead 114. The secondary coils from FFST 104 to the conductive power plates 108 is shown by the leads 116. The operation of device 100 can be controlled by signals from 118 to HFHV 106 by control box 120. The levitation is achieved by controlling the electric field in the stack of conductive power plates 108 by the FFST 104 depending upon the induced polarization of the uncharged and non-magnetized arbitrary surface 110.

Referring now to FIG. B, FIG. B shows a schematic 200, which shows details for the force feedback step-up transformer (FFST) as described in FIG. A. The FFST comprises a frequency control 202. The frequency control 202 regulates frequency at which high voltage oscillates by transmitting signals that change the permeability of a variable permeability transformer (VPST) 204. The signals sent to VPST 204 depend on the output of a force sensor 206. When a repulsive force is sensed by the force sensor, the frequency of VPST 204 decreases so as to maintain the charge polarity on the power plate, which will generate repulsion from the uncharged and non-magnetized arbitrary surface 110 (FIG. A). When attractive or neutral force are sensed by the force sensor 206, it prompts the frequency control 202 to increase the frequency of VPST 204 and thereby to rapidly switch the charge polarity of the conductive power plates 108 (FIG. A). The input leads 208 to VPST 204 are from HFHV 106 (FIG. A), and frequency control 202 feeds signals 210 to VPST 204. The leads 212 are from secondary coil of VPST 204 to stack up of conductive power plates 108 (FIG. A). The force sensor feed forward signal 214 determines the nature of the force, which can be attractive, repulsive or neutral.

Referring now to FIG. C1, FIG. C1 shows a cross sectional view 300 for a stack-up of conducting power plates for the levitation vehicle. The cross sectional view comprises an engine chassis 302, a stack-up of conductive power plates 308, and conductors 304, 306 for the electromagnetic levitation vehicle. The number of conductive power plates 308 can be about 20. The gap 306 between the power plates is about 1.0 inch. The stack of conductive power plates 308 care connected to conductors 304, 306 through electrical connections (308) (n=20) and the corresponding connecting leads (n=20) for each conductor. The conductor 304 and 306 are of opposite polarity depending on the output from the FFST 104 (FIG. A). The polarity of stack of conductive power plates 308 is changed in such a controlled manner that a repulsive force between the uncharged and non-magnetized arbitrary surface 110 (FIG. A) and the stack of conductive power plates initiates levitation of the conductive power plates and the chassis 102 (FIG. A) to which it is attached. This embodiment will have fields only from the parts facing towards the uncharged and non-magnetized arbitrary surface 110(FIG. A).

Referring now to FIG. C2, FIG. C2 illustrates a schematic 300, which comprises single power plate 308 (FIG. C1), thin metal foils 310-326, the corresponding leads that connect thin metal foils arranged in Halbach configuration, connecting leads 330 (with negative charge) and 332 (with positive charge) from the secondary coils from VPST 204 (FIG. B). The thin metal plates 310-328 can be Aluminum with a thickness of about 0.5 inch and length of about 15 feet. The schematic 300 illustrates the charge mechanism for the single power plate 308. The charge is switched between positive to negative charge at a rate, which initiates levitation.

Referring now to FIG. D, FIG. D shows an alternate arrangement 400 of a stack-up of conducting power plate 400. The alternate arrangement comprises the chassis 402, a set of about twenty conducting power plates 404. The conductor 606 and the lead (−q) 408 connect to the secondary coil of VPST 204 (FIG. B). The chassis 402 supports the conducting power plates 404. The conducting power plate 404 material can be Aluminum. This embodiment, unlike FIG. C1 can have the electric field generated both from the top and the bottom of stack up of conducting power plates.

Referring now to FIG. E, FIG. E shows an alternate arrangement 500 for the force feedback step-up transformer (FFST). The arrangement 500 comprises a chassis 502, force feedback step-up transformer 504, force sensor 506, control capacitor 508, connecting leads 510, 512 from HFHV generator (not shown in FIG. E) to FFST 504 and 514. The connecting lead 516 to control capacitor 508, leads 518 and 520 from secondary coil of FFST 504 to HFHV generator and lead 522 to the force sensor 506. In this embodiment, output from secondary coil of FFST 504 is controlled by the control capacitor 508. The force sensor 506 controls the capacitor 508. When there is no repulsion, the capacitance is reduced by the force sensor, thereby increasing the frequency and rapidly switching the conducting power plate (not shown in FIG. E) polarity that will generate repulsion. If there is repulsion, the capacitance is increased, thereby decreasing the frequency of the secondary output, and thus maintaining the desired repulsion.

### DESCRIPTION OF EMBODIMENTS

If an electric field is applied to an insulator, for example a cement or wooden wall, such an insulator will undergo dielectric polarization in that given that electric field E is applied, charges of opposite sign to E will be pulled towards the surface while charges of like sign will be repelled. A common example of this effect is that which can be brought about by charging a balloon by rubbing it against hair or another material suitably positioned in the tribo-electric series and allowing it to stick against the wall. Forces due to such elementary demonstrations can be quite significant, for example it is worth noting that the electrostatic force between a balloon and the wall is typically more than enough to carry the weight of the balloon. A much more visceral example can be had through the use of Van Der Graff generators. If the electric charges could somehow be switched in polarity while maintaining the same charge magnitude, then it would be possible to levitate objects from arbitrary surfaces since all material surfaces contain dipoles and are therefore electrically polarizable. In the embodiments disclosed in this patent application, method and apparatus are disclosed which accomplishes just this switching of charge polarity in order to cause the levitation of objects.

To motivate the idea behind the physics of the embodiments disclosed in this patent application, FIG. A0 is referred to where a charged balloon and a wall is used for illustration. The series of figures in FIG. A0 illustrates what happens when a positively charged balloon is first brought close to a wall, removed and replaced by a negatively charged balloon within the time when the initially induced negative charges on the wall retreat from the surface of the wall. In the configuration of part (c) of FIG. A0, it can be seen that the balloon will be repelled from the wall during the time τ when the negative charges are still on the wall. By automatically responding for of any given surface, the embodiments disclosed in this patent application basically does this task automatically in such a way that it is repelled and thus levitated away from an arbitrary surface.

In order to shed light on the possibility of using dipole polarization of insulators for the purpose of levitation, we reduce the physical picture as so depicted in FIG. A1. For conductors, the situation is a bit different because all the charges are free but the levitation vehicle disclosed in embodiments in this patent application is designed in such a way that this does not present a problem to the levitation process as will soon be described.

In FIG. A1, a positive electric field due to the metal sheet of the levitator E>0 is defined as electric field directed out of the metal plate and of course is defined opposite for negative electric field E<0. Here (1) in FIG. A1 is the surface which the vehicle is levitated on. It is represented as having a distribution of dipoles which are polarizable depending on the electric field E, which are represented by dashed lines, coming from the vehicle (2). The levitation height is represented by y and xz is the surface area of one of the conducting sheets of the vehicle. When −E₀ is applied from (2) and held for a while, where E₀>0, positive charges are pulled to the surface of (1) and when E₀ is applied for a while, negative charges are pulled to the surface. Note that this is not what is depicted in FIG. A1 which is a depiction of the vehicle (1) in a given instant in the act of levitation.

Referring to FIG. A1, suppose that an electric field −E₀ is initially applied to (1) from (2), then positive charges of amount Q will be pulled to the surface. Now if the electric field is abruptly removed, the positive charges induced on the surface will be removed after some characteristic time τ as in the case of the balloon of FIG. A0. So if during that time τ the −E₀ is replaced by E₀, the positive charges will be forced away by the electric field and negative charges will then be brought up to the surface. During the time in which positive charges are still on the surface, when the field is replaced by E₀ a repulsive force will act between (1) and (2). The repulsive force will continue to be active until the positive charges are removed from the surface. Now if at this time the electric field E₀ is removed, negative charges will still appear on the surface even without the application of any electric field because the previous application of E₀ on (1) gave momentum to those negative charges and the momentum that is contained by the negative charges will draw the negative charges up to the surface while the momentum that is still contained by the positive charges will move the positive charges away from the surface, although more momentum is clearly delivered to the positive charges at this instant, and in the case when negative charges are on the surface and the applied electric field is switched in sign, more momentum will be given to the negative charges. If it is arranged that close to the time that negative charges eventually appear in (1) that an electric field of −E₀ is then applied, then there will be repulsive force acting between (1) and (2) because the newly produced negative charges on the surface will cause the repulsion. If this process is continually repeated, then the source of the electric field (2) which is the vehicle will remain levitated above the surface. Embodiments disclosed in this patent application are methods and apparatus that performs precisely the described switching of electric fields in order to induce and maintain levitation. Since we are dealing with an insulator, the charges are firmly attached in the material and the system can be roughly approximated as an elastic oscillator with the appropriate Young's modulus, some mass M and being excited by force QE where Q is the charge induced on the surface of levitation (1) and E is the electric field emanating from (2) in FIG. A1. Here, the equations of motion for the surface material on which the vehicle is levitated will be obtained.

Doing this will allow for the demonstration of the functional dependence of the frequency of oscillation of the electric field E and also of the oscillations of (2) as well as help to more clearly demonstrate the workings of the invention. The amount of displacement that the surface material (2) is displaced by must be proportional to the amount of charge that is brought up to the surface since a stronger electric field will displace more material and also draw up more charge. Even if no fields are applied after a period of electric field application, charges will still be oscillating back and forth for a while in the surface material, being brought in and out of the surface in the surface material because of the inertia and mechanical energy still present as delivered to the charges by the previously applied electric fields (although a part of this energy will be transferred to heat as well as non-polarizing vibrations of the material, the charges will still be oscillating into and out of the surface material for a while). This phenomena is then guided roughly by equation of the form

$$\ddot{δ} = - {ω}^{2} δ + \frac{F}{M} \qquad equation ( 1 )$$

where δ is the displacement of the material which makes up (2) and F is the force applied on (2) due to the electric field E from (1) and ω is a natural frequency of the material. So since F=QE, if a relation can be found for Q to δ then it can be used in equation (1). For a displacement δ, we have a restoring force F₀=−Mω²δ, assuming that in the absence of applied electric field E, that the restoring force is caused by the dipole polarization and also assuming that the area of the surface that is affected by the dipole polarization (and also the metal sheet) is large enough that the electric field can be considered parallel up to an appreciable depth into the surface material gives

$$\frac{{Q}^{2}}{ɛ} = M {ω}^{2} δ \qquad equation ( 2 )$$

where ∈ is the dielectric constant of the surface material. Thus

Q=±\sqrt{∈Mω²δ} equation (3)

Since in the surface material, we have both positive and negative charges, we must define 2 equations

$${\ddot{δ}}_{+} = - {ω}^{2} {δ}_{+} - \frac{{Q}_{+} {E}_{+}}{{M}_{+}} \qquad equation ( 4 )$$

for the positive charge, and

$${\ddot{δ}}_{-} = - {ω}^{2} {δ}_{-} - \frac{{Q}_{-} {E}_{-}}{{M}_{-}} \qquad equation ( 5 )$$

for the negative charge where Q₊ is for the positive charges and Q₋ is for the negative charge and M₊, M₋ are the masses of the positive and negative charges respectively. The negative sign in front of the 2^{nd} term on the right hand side of equation (4) and equation (5) comes from the fact that a positive/negative electric field according to the metal plate is a negative/positive electric field according to the surface. Embodiments that are disclosed in this patent application generate electric fields in order to cause and maintain levitation by using the following prescription referred to in this patent application as the E-field switching algorithm.

### E-Field Switching Algorithm:

1) If Q₊ rises to the surface, that E₊>0 (that is according to the convention of the sign of the electric field that positive electric field is directed away from the surface of the source of the electric field). This means that a repulsive force is acting between the vehicle and the surface and a restoring force is acting on the surface charges Q₊ because the electric field lines from the surface due to the charges Q₊ (which is directed out of the surface) and that of E₊ (which is directed out of the metal sheet(vehicle)) are in opposite directions.
2) If Q₋ rises to the surface, that E₋<0 (that is according to the sign convention that negative electric field is directed toward the surface of the source of the electric field). This means that a repulsive force is acting between the vehicle and the surface and a restoring force is acting on the surface charges Q₋ because the electric field lines from the surface due to the charges Q₋ (which is directed into the surface) and that of E₋ (which is directed into the metal sheet(vehicle)) are in opposite directions.
   Essentially, this means that the electric field from the metal plate will always act as a restoring force to the charges regardless of the displacement δ, coupled with the condition of E₊=−E₋, and using the assumption that δ₊δ₋=δ, |Q₊|=|Q₋|=|Q|, and M₊=M₋ and adding up equation (4) and equation (5), there is obtained

$$\ddot{δ} = - ( {ω}^{2} + \frac{2}{M} \sqrt{\frac{M {ω}^{2} ɛ}{δ}} {E}_{0} ) δ \qquad equation ( 6 )$$

This opportunity will be used to point out that this system is a parametric oscillator which is a well known system with applications in a wide variety of fields.

In order to increase the magnitude of the oscillations on the surface of levitation, embodiments disclosed in this patent application are disclosed which use the following prescription that is referred to in this patent application as the resonance delivery algorithm:

Resonance Delivery Algorithm:
1) If Q₊ is on the surface and Q₊ is a decreasing function of time, that E₊>0 (that is according to my convention of the sign of the electric field), if Q₊ is on the surface and Q₊ is an increasing function of time, that E₊=0. This means that a repulsive force is acting between the vehicle and the surface and a restoring force is acting on the surface charges Q₊ only when Q₊ is traveling down into the surface. This has the effect of delivering a non-zero net kinetic energy to the surface material when Q₊ is on the surface.
2) If Q₋ is on the surface and Q₋ is a decreasing function of time, that E₋<0 (that is according to my convention of the sign of the electric field), if Q₋ is on the surface and Q₋ is an increasing function of time, that E₋=0. This means that a repulsive force is acting between the vehicle and the surface and a restoring force is acting on the surface charges Q₋ only when Q₋ is traveling down into the surface. This has the effect of delivering a non-zero net kinetic energy to the surface material when Q₋ is on the surface
   For the case where the surface is a conductor, the charges are not fixed in the surface material so the situation cannot simply be modeled as a spring system like an insulator. Instead, the surface then has capacitance Cₛ, resistance Rₛ and inductance Lₛ. Referring to FIG. A2, if E=−E₀ is initially applied, positive charges are attracted to the surface (note that the picture depicted in FIG. A2 is the vehicle in a momentary act of levitation not what has just been described), and when the electric field is removed, the surface is neutralized in a characteristic time

$$τ = \frac{\sqrt{{L}_{s} {C}_{s}}}{4} .$$

Now if during this time, the field is replaced with E=E₀, then for the duration of the time when the surface charge is positive, there will be repulsive forces acting between (1) and (2) until the surface becomes neutral. Now just after or just before the surface becomes occupied by negative charges (which will eventually be the case since this is essentially an LCR system) a field of E=−E₀ can then be applied at this time in order to maintain a repulsive force between (1) and (2).

We can get a rough estimate of the repulsive force that can act on a metal foil of unit surface area on a typical surface like concrete. We can limit the field of the foil to about 3Mv/m. The charge on the surface is approximately

$$\frac{{ɛ}_{surface} - {ɛ}_{0}}{{ɛ}_{surface} + {ɛ}_{0}} {ɛ}_{0} {E}_{0} \qquad equation ( 7 )$$

where ∈_{surface}, ∈₀ are the dielectric constants of the surface material and the medium between (1) and (2) respectively (Note that ∈₀ is the symbol used for the dielectric constant of a vacuum but in FIG. A2 the medium between (1) and (2) will almost invariably be air, but the difference is negligible since the dielectric constant for air and vacuum are very close). The force acting between (1) and (2) is then

$$\frac{{ɛ}_{surface} - {ɛ}_{0}}{{ɛ}_{surface} + {ɛ}_{0}} {ɛ}_{0} {E}_{0}^{2} \qquad equation ( 8 )$$

A survey of insulator dielectric constants reveal the following:
Concrete: ∈_{surface}=45∈₀
Paper: ∈_{surface}=3.5∈₀
Silicon dioxide (A.K.A. Sand): ∈_{surface}=4.5∈₀
Conductors ∈_{surface}→∞
Where ∈₀=8.854×10⁻¹² F/M

For insulators, we take a typical ∈_{surface}=4.56∈₀, so that
Fᵢₙₛᵤₗₐₜₒᵣ≈51.0 Newtons

For conductors, that figure becomes
F_{conductor}≈72.0 Newtons

The frequency of the oscillations is automatically controlled by the mechanisms in the levitation vehicle such that a repulsive force is generated between the surface and the levitation vehicle. It is expected that the frequency of oscillation that is necessary to induce and maintain levitation will vary with different surface material. It is also expected that the frequency of oscillation that is necessary to induce and maintain levitation will be time dependent.

In FIG. 2a and FIG. 2b, the conductive power plates that are inside the simple field plate assembly is the source of the electric fields. For FIG. 2c, the vertical and horizontal metal field plates are the source of the electric fields. Its function is to spread electric field over a large area on the surface and thus polarize that large area, thus making large the area of the surface in which charge is induced by the electric field from the metal plates so that the force on the levitating system can be large enough to levitate the vehicle without exceeding the breakdown voltage of the surrounding media (i.e. air) and also producing the effect that due to the fact that a large area of the surface contains charge, the electric field due to that area of surface charge can reach a considerable distance from the surface on which the levitation vehicle is being levitated to the vicinity of the levitation vehicle since as is well known in electrostatics, the electric field at a distance from a large sheet of charge of uniform charge density is approximately σ/∈ where σ is the charge density on the sheet. The important point is that for an appreciable distance from the sheet of charge induced on the surface on which the vehicle is being levitated the electric field is only weakly dependent on the distance away from that sheet of charge. The electric field will eventually be strongly dependent on the distance away from the surface (since the area of the charge on the surface is not actually infinite) but the point is that for a large distance from the surface, this dependence on distance will be weak. The advantage of this weak dependence on the distance away from the surface of the electric field is that the repulsive force on the vehicle can then be increased by simply stacking more conductive power plates, one atop another since with a large area of charge on the surface, the fields due to these charges on the surface reach further out into the air so that extra metal sheets higher up can feel roughly the same repulsive force as lower ones. This is the reason for the stacking of the conductive power plates one on top of the other.

The E-Field switching algorithm is implemented with the top electrometer and bottom electrometer as shown in (FIG. 2a, FIG. 2b, FIG. 2c) and the simple feedback control (FIG. 3a, FIG. 3c) or the compound feedback signal control (FIG. 3b).

The way that force detection is achieved by the top electrometer and the bottom electrometer is as follows:
If the magnitude of the electric field measured by the top electrometer is higher than the magnitude of the electric field measured by the bottom electrometer, then this means that a repulsive force is acting between the system and the surface but if the magnitude of the electric field measured by the top electrometer is lower than the magnitude of the electric field measured by the bottom electrometer, then this means that an attractive force is acting between the levitation vehicle and the surface. The top electrometer and the bottom electrometer (FIG. 2a, FIG. 2b, FIG. 2c) measures the magnitude of the electric field in their vicinities and feeds it to comparators (FIG. 3a, FIG. 3c) or subtractors (FIG. 3b). Thus the output of the comparator (FIG. 3a, FIG. 3c) or the adder (FIG. 3b) provides information on the nature of the force that is acting on the levitation vehicle due to the induced dielectric polarization of the surface on which the levitation vehicle is being levitated.
In (FIG. 3a, FIG. 3b, FIG. 3c) the voltage controlled oscillator implements the E-Field switching algorithm by changing its frequency in response to the output of the comparator (FIG. 3a, FIG. 3c) or the adder (FIG. 3b) as follows:
   The voltage controlled oscillator should output low frequency when the levitation vehicle is being acted on by a repulsive force and a high frequency when the levitation vehicle is being acted on by an attractive or neutral force is the following: The polarity of output of transformer Vx in FIG. 4 will depend on whether the output (OVb) is rising or falling henceforth referred to the changing state of (OVb). Here (OVb) refers to the output that is depicted in (FIG. 3a, FIG. 3b, FIG. 3c). If repulsive force is acting on the levitation vehicle, then it means that the dielectric polarization of the surface on which the levitation vehicle is being levitated on and the changing state of (OVb) are such that they cause repulsive force on the levitation vehicle. In this case, the frequency of the voltage controlled oscillator should remain low if it was initially low or should be made low if it was initially at high in order to maintain the changing state of (OVb) which causes levitation. If attractive or neutral force is acting on the levitation vehicle, then it means that the dielectric polarization of the surface on which the levitation vehicle is being levitated on and the changing state of (OVb) are such that they cause attractive force or no force on the levitation vehicle. In this case, the frequency of the voltage controlled oscillator should remain high if it was initially high or should be made high if it was initially low in order to change the changing state of (OVb) to a state that will cause repulsion on the levitation vehicle. Thus the levitation vehicle spends much more time for a given time interval in a state of repulsion between the levitation vehicle and the surface and thus the levitation vehicle stays levitated.

What is claimed is:

1. A method for levitating a vehicle, comprising the actions of:
using a high frequency high voltage source;
using a force feedback step-up transformer; and
generating a repulsive force between an electrically charged a stack of conducting power plates and an uncharged and non-magnetized arbitrary surface.

2. The method of claim 1, wherein the stack of conducting power plates can generate electric field towards the bottom and the top of the plates.

3. The levitation vehicle of claim 1, wherein the variable frequency high voltage system can measure the force between the stack of conductive power plates and the uncharged and non-magnetized arbitrary surface and can rapidly change the polarity of the power plates to initiate and maintain the desired level of levitation.

4. The levitation vehicle of claim 1, wherein a control capacitor is used to change the frequency of the output of the high frequency high voltage source in order to switch the polarity of the electric field that is produced by the conductive power plates in response to the dielectric polarization of the uncharged and non-magnetized arbitrary surface and therefore cause levitation.

5. The levitation vehicle of claim 1, wherein the operating ranges of the levitation vehicle can be about 5 feet in height.

6. A method for levitating a vehicle comprising the action of:
Using a plurality of levitation drive units; and
Using a user control station.

7. The method of claim 6, wherein the levitation drive unit contains a simple field plate assembly, a high voltage transformer drive and a simple feedback signal control or a compound feedback signal control.

8. The method of claim 7, wherein the simple field plate assembly contains conductive power plates.

9. The method of claim 8, wherein the conductive power plates generate electric fields.

10. The method of claim 9, wherein the levitation vehicle can be levitated on an uncharged and non-magnetized arbitrary surface with the electric fields that are generated by the conductive power plates.

11. The method of claim 10, wherein the uncharged and non-magnetized surface can be a conducting or non-conducting surface.

12. The method of claim 7, wherein the simple field plate assembly contains a top electrometer and a bottom electrometer.

13. The method of claim 12, wherein the top electrometer measures the magnitude of the electric field in the vicinity of the top of the simple field plate assembly and the bottom electrometer measures the magnitude of the electric field in the vicinity of the bottom of the simple field plate assembly.

14. The method of claim 13, wherein the output of the top electrometer and the output of the bottom electrometer are fed into a simple feedback signal control.

15. The method of claim 14, wherein the simple feedback signal control calculates the nature of the force between the simple field plate assembly and the uncharged and non-magnetized arbitrary surface and wherein the simple feedback signal control changes the frequency of the output of a voltage controlled oscillator in response to the nature of the force that is acting between the simple field plate assembly and the uncharged and non-magnetized arbitrary surface and wherein the output from the voltage controlled oscillator is used to produced high voltage output from a step-up transformer.

16. The method of claim 15, wherein the output of the step-up transformer is fed into the conductive power plates of the simple field plate assembly and wherein the output of the step-up transformer causes electric fields to be generated from the conductive power plates which can be used to cause levitation of the levitation vehicle of claim 6.

17. The levitation vehicle of claim 6, wherein the user can control the levitation drive unit to cause levitation by using the user control station.

18. The levitation vehicle of claim 6, wherein the levitation drive unit can contain a compound field plate assembly or can contain a Halbach array field plate assembly.

19. The levitation vehicle of claim 6, wherein horizontal motion can be produced by positioning some levitation drive units at angles of about 45° relative to the surface on which the levitation vehicle is being levitated on or wherein horizontal motion can be produced with the use of propellers.

20. The levitation vehicle of claim 6, wherein the dielectric polarization of the surface on which the levitation vehicle is being levitated on can be increased by implementing the resonance delivery algorithm and wherein the operating ranges of the levitation vehicle can be about 6 feet.
